(19) United States
(12) Patent Application Publication
(10) Pub. No.: US 2009/0200800 A1
(43) Pub. Date: Aug. 13, 2009

(54) HOSE CONNECTOR AND A METHOD FOR FABRICATING A HOSE CONNECTOR ON A HOSE

(76) Inventor: Po-Wen Chen, Guantian Hsiang (TW)

Correspondence Address: CHRISTOPHER P. MAIORANA, P.C., 24840 HARPER SUITE 100, ST. CLAIR SHORES, MI, 48080, US

(21) Appl. No.: 12/028,882

(22) Filed: Feb. 11, 2008

(51) Int. Cl. F16L 19/00

(52) U.S. Cl. 285/353

(57) ABSTRACT

A hose connector is mounted on an open end of a hose and has a bushing, a nut and at least one collar. The bushing has an insertion section mounted in the open end of the hose. The nut is mounted detachably around the bushing, is mounted around the hose and has a compressing flange formed on the nut. The at least one collar is mounted around the hose, mounted rotatably in the nut, abuts the compressing flange and presses tightly against the open end of the hose. The insertion section of the bushing and the at least one collar cooperate to tightly hold the hose in the hose connector. The hose cannot easily fall out of the hose connector inadvertently when external forces pull the hose or the hose connector.

### BACKGROUND OF THE INVENTION

1. Field of the Invention

The present invention relates to a connector, and more particularly to a hose connector that is attached securely to a hose without damaging the hose.

2. Description of Related Art

Hoses are used in semiconductor, pharmaceutical and food processing industries for transportation of fluids. The hoses are usually connected together through intervening hose connectors. Because the fluid material transported in the hoses is frequently poisonous or perishable when exposed to air, preventing leakage between the connected hoses and the hose connectors is of great importance.

With reference to FIG. 10, a conventional hose connector is mounted on an open end of a hose (80a) and has a bushing (60a) and a nut (70a). The bushing (60a) has an inside end, an outside end, an insertion section and an outer thread. The insertion section is formed axially on the bushing (60a) adjacent to the inside end and is mounted in one open end of the hose. The outer thread is formed around the bushing (60a) near the outside end. The nut (70a) is cylindrical and has a mounting end, a clamping end, an inner thread and an inner flange. The inner thread is formed on the nut (70a) adjacent the mounting end and engages the outer thread of the bushing (60a). The inner flange is formed on and protrudes radially inward from the clamping end and cooperates with the inside end of the bushing (70a) to clamp the hose (80a) and prevent the hose from separating from the hose connector when the hose is pulled inadvertently.

However, since the nut (70a) is usually harder than the hose (80a), the nut (70a) wears and cuts the hose (80a) when the hose connector is assembled to the hose (80a), so the hose (80a) is easily damaged. When the nuts (70a) are not harder than the hose (80a), the hose connector, when inadvertently pulled, is separated easily from the hose (80a).

With further reference to FIGS. 11 and 12, another conventional connector is mounted on a hose (80) with an enlarged open end (81) and has an inner bushing (50), an outer bushing (60) and a nut (70). The inner bushing (50) is mounted in the enlarged open end and has an annular bulge (51) formed around the inner bushing (50).

With further reference to FIG. 13, the enlarged open end (81) is formed from an open end processed by a compressing machine having a compressing cylinder (90) and a stopper (91). The compressing cylinder (90) is located around the hose (80) and moves toward the annular bugle (51) of the inner bushing (50) to press against the open end mounted around the annular bugle (51) to form an annular shoulder (82) around the hose (80) and form the enlarged open end (81). The stopper (91) abuts and holds the inner bushing (50).

The outer bushing 60) is mounted around inner bushing (50) and the enlarged open end (81) of the hose (80) and has an inner surface and an outer thread. The inner surface is concave to correspond to the annular bulge (51). The nut (70) is mounted around the hose (80), abuts the annular shoulder (82) of the hose (80) and has an inner thread engaging the outer thread of the outer bushing (60).

However, forming the enlarged open ends (81) on the hoses (80) wastes times and lowers rate of manufacture of mounting the hose connectors on the hoses (80). Furthermore, the concave inner surface of the outer bushing (60) the annular bugle (51) of the inner bushing (50) and together with slow rate of manufacture, make the structure of the hose connector complicated and have a high cost.

To overcome the shortcomings, the present invention provides a hose connector to mitigate or obviate the aforementioned problems.

### SUMMARY OF THE INVENTION

The main objective of the invention is to provide a hose connector that is attached securely to a hose without damaging the hose.

A hose connector is mounted on an open end of a hose and has a bushing, a nut and at least one collar. The bushing has an insertion section mounted in the open end of the hose. The nut is mounted detachably around the bushing, is mounted around the hose and has a compressing flange formed on the nut. The at least one collar is mounted around the hose, mounted rotatably in the nut, abuts the compressing flange and presses tightly against the open end of the hose. The insertion section of the bushing and the at least one collar cooperate to tightly hold the hose in the hose connector. The hose cannot easily fall out of the hose connector inadvertently when external forces pull the hose or the hose connector.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a hose connector in accordance with the present invention;

FIG. 2 is an operational cross sectional side view of the nut of the hose connector in FIG. 1 mounted on the hose;

FIG. 3 is an operational cross sectional side view of the bushing of the hose connector in FIG. 2 mounted in the open end of the hose;

FIG. 4 is an operational cross sectional side view of the nut engaging the bushing of the hose connector in FIG. 3 and tightly clamping the hose between the nut and the bushing;

FIG. 5 is an operational cross sectional side view of the hose connector in FIG. 4 completely mounted on the hose;

FIG. 6 is an operational cross sectional side view of a second embodiment of a hose connector in accordance with the present invention mounted on a hose;

FIG. 7 is an operational cross section side view of a third embodiment of a hose connector in accordance with the present invention mounted on a hose;

FIG. 8 is an operational cross sectional side view of a fourth embodiment of a hose connector in accordance with the present invention mounted on a hose;

FIG. 9 is an operational cross sectional side view of a fifth embodiment of a hose connector in accordance with the present invention mounted on a hose;

FIG. 10 is a cross sectional side view of a conventional hose connector in accordance with the prior art mounted on a hose;

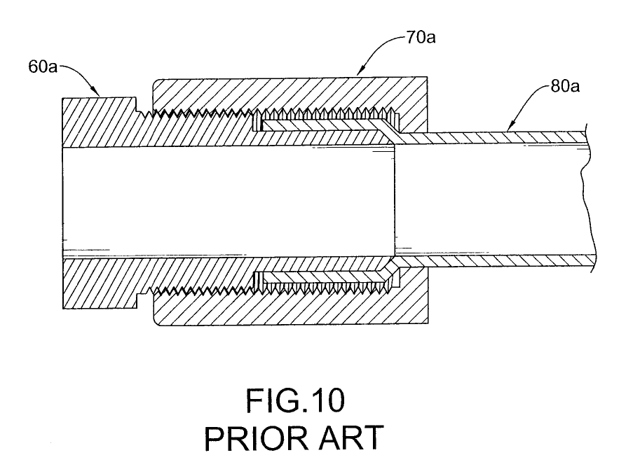

FIG. 11 is a partially exploded cross sectional side view of another conventional hose connector in accordance with the prior art mounted on a hose;

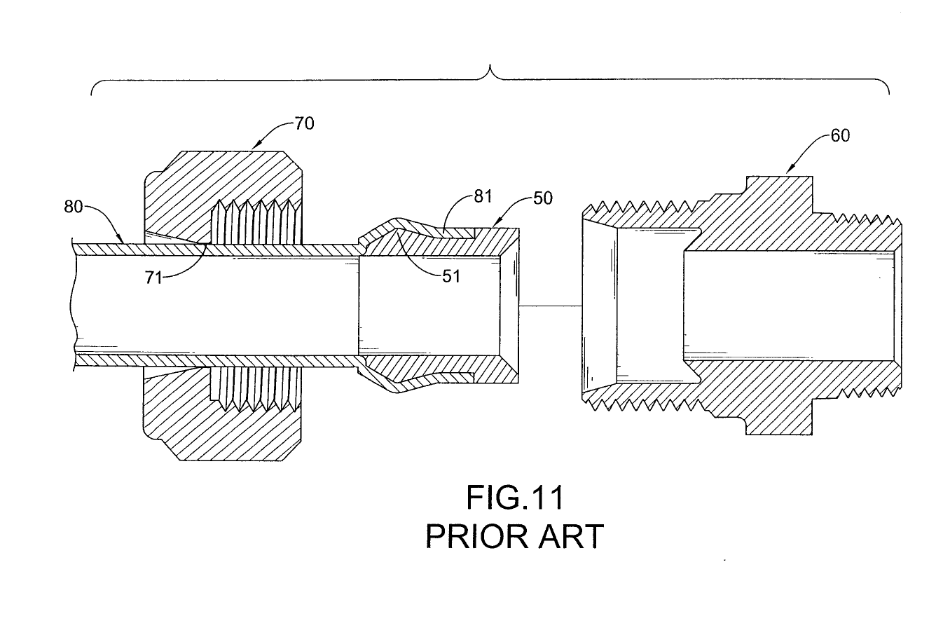

FIG. 12 is a cross sectional side view of the conventional hose connector in FIG. 11 mounted on the hose; and

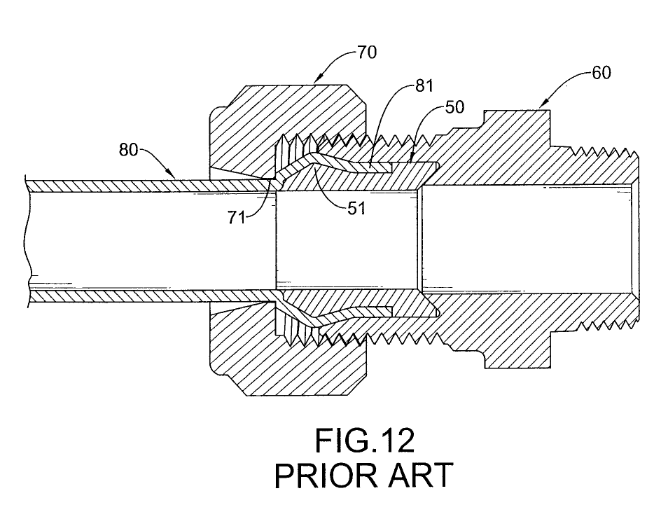

FIG. 13 is an operational side view in partial section of the hose mounted on the inner bushing of the hose connector in FIG. 12 processed by the compressing machine.

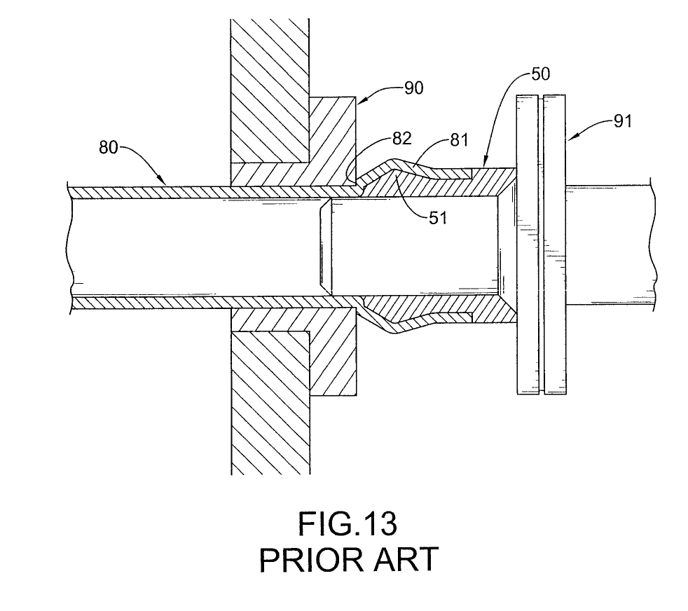

### DETAILED DESCRIPTION OF THE PREFERRED EMBODIMENT

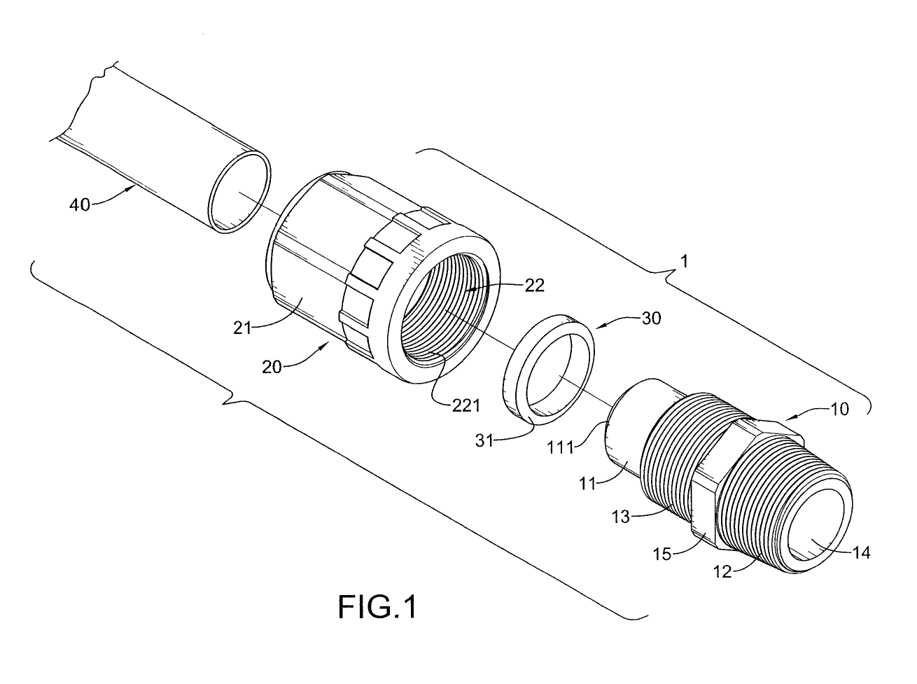

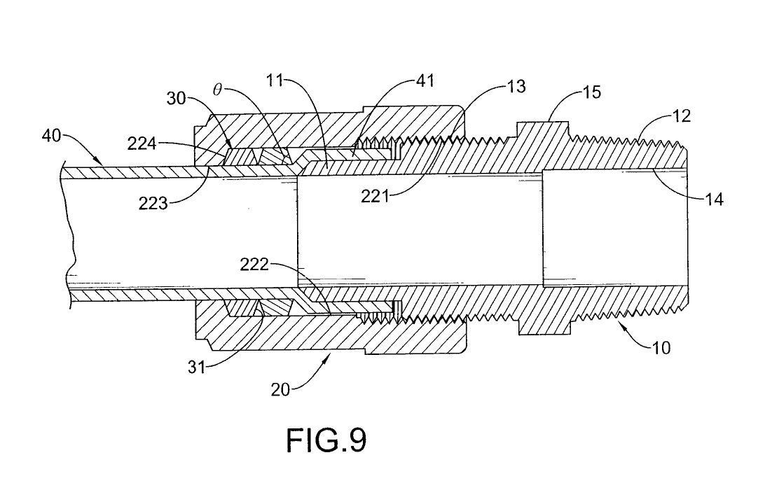

With reference to FIGS. 1 and 5-9, a hose connector (1) in accordance with the present invention is mounted on a hose (40). The hose (40) has an open end (41) that would be enlarged when the hose connector (1) is mounted on the open end (41) of the hose (40).

The hose connector (1) comprises a bushing (10), a nut (20) and at least one collar (30).

The bushing (10) has an outer surface, an inside end, an outside end, a central hole (14), an insertion section (11) and an engaging thread (13) and may further have an outside thread (12) and a tool operating flange (15).

The outside end is opposite to the inside end.

The central hole (14) is defined axially through the bushing (10) and has an inner surface.

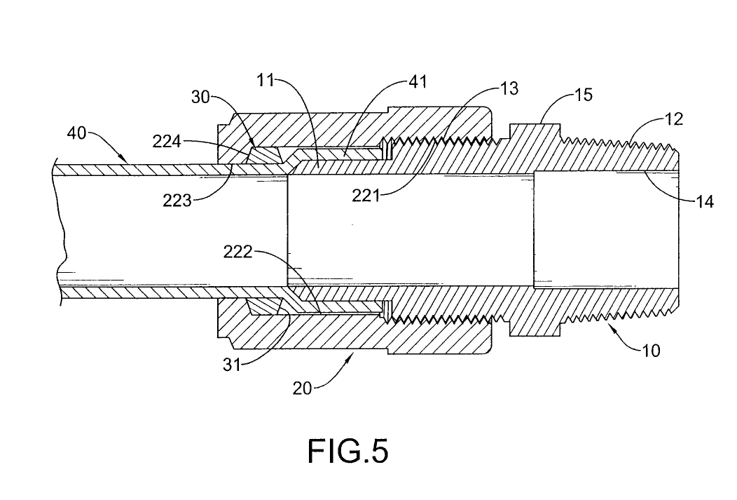

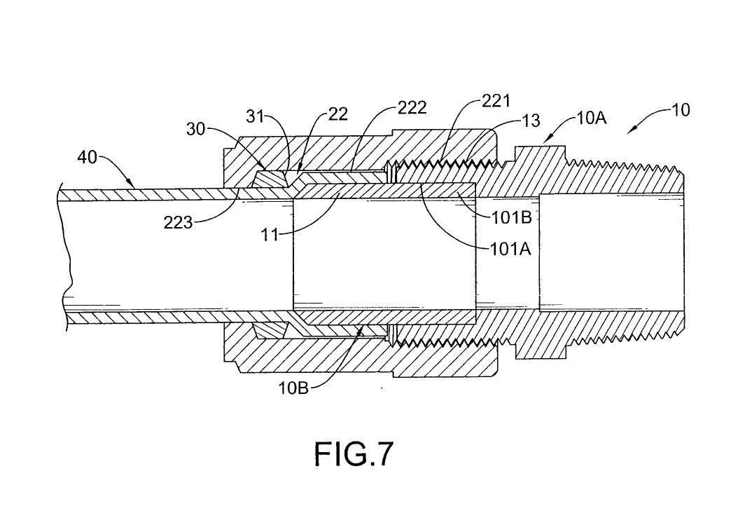

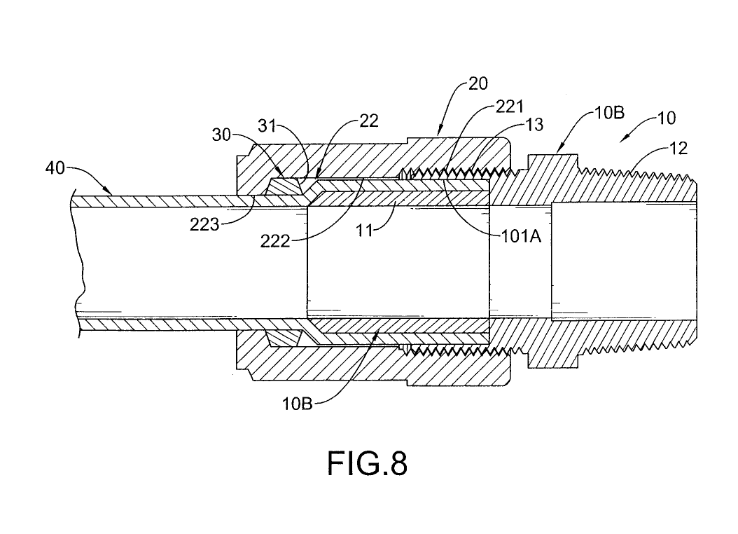

The insertion section (11) is attached to the bushing (10) adjacent to the inside end, is inserted into and enlarges the open end of the hose (40) and has an outer diameter. First, second and fifth embodiments of the hose connector (1), as shown in FIGS. 5, 6 and 9, have the insertion section (11) formed integrally on the bushing (10). In third and fourth embodiments of the hose connector (1), as shown respectively in FIGS. 7 and 8, the bushing (10) is implemented as a bushing member (10A) and an inner cylinder (10B). The bushing member (10A) includes the outside end and central hole (14) defined through the bushing member (10A) and has two open ends and an annular recess (101A). The annular recess (101a) is defined in the inner surface of the central hole (14) at one open end and has an inner diameter and a side surface. The inner cylinder (10B) is mounted detachably in the annular recess (101A) and has a first end, a second end (101B) and an outer diameter. The insertion section (11) is formed on the first end of the inner cylinder (10B). The second end (101B) is mounted detachably in the annular recess (101A). In the third embodiment, the inner diameter of the annular recess (101A) is equal to the outer diameter of the inner cylinder (10B), as shown in FIG. 7. In the fourth embodiment, the inner diameter of the annular recess (101A) is larger than the outer diameter of the inner cylinder (10B) so that a gap is defined between the side surface of the annular recess (101A) and the inner cylinder (10B) to receive the open end (41) of the hose (40), as shown in FIG. 8.

The engaging thread (13) is formed on the outer surface of the bushing (10) adjacent to the insertion section (11) and has an outer diameter larger than that of the insertion section (11). In the third and fourth embodiments of the hose connector (1), the engaging thread (13) formed on the bushing member (10A) of the bushing (10).

The outside thread (12) is formed on the outer surface of the bushing (10) at the outside end and may engage a thread on a nozzle or a connector. The third and fourth embodiments of the hose connector (1) have the engaging thread (13) formed on the bushing member (10A) of the bushing (10).

The tool operating flange (15) is annular and polygonal, may be hexagonal or octagonal and is formed on and protrudes radially out from the bushing (10) between the engaging thread (13) and the outside thread (12). The tool operating flange (15) may be engaged by a wrench so that the bushing (10) may be rotated by the wrench. The third and fourth embodiments of the hose connector (1) have the tool operating flange (15) formed on the bushing member (10A) of the bushing (10).

The nut (20) is cylindrical, is mounted detachably around the bushing (10), is mounted around the hose (40) and has a connecting end, a compressing end, a mounting hole (222), an engaging thread (221) and a compressing flange (223).

The compressing end is opposite to the connecting end.

The mounting hole (222) is defined axially through the nut (20), is mounted around the bushing (10) and has an inner surface.

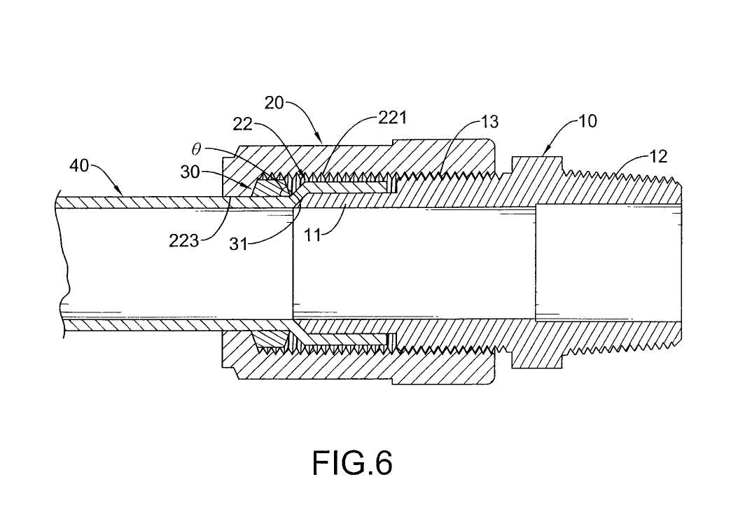

The engaging thread (221) of the nut (20) is formed on the inner surface of the mounting hole (222) adjacent to the engaging end and detachably engages the engaging thread (13) on the bushing (10). In the first, third, fourth and fifth embodiments of the hose connector (1), the engaging thread (221) of the nut (20) is formed partially on the inner surface of the mounting hole (222) at an interval from the compressing end, as shown in FIGS. 5 and 7 to 9. In the second embodiment, the engaging thread (221) is formed all along the inner surface of the mounting hole (222), as shown in FIG. 6.

The compressing flange (223) is formed on and protrudes radially inward from the inner surface of the mounting hole (222) adjacent to the compressing end.

The at least one collar (30) is annular, is mounted around the hose (40), is mounted rotatably in the mounting hole (222) in the nut (20), abuts the compressing flange (223), aligns with the insertion section (11) of the bushing (10) and is pressed by the compressing flange (223) to press tightly against the enlarged open end (41) of the hose (40). Each collar (30) has an inside surface and two opposite side surfaces (31). The collar (30) is harder than the hose (40). The inside surface contacts the hose (40). Each side surface (31) has an included angle (θ) between the inside surface and the side surface (31) in a range of 30 to 95 degrees. When the included angle (θ) is less than 30 degrees, the collar (30) is too sharp to tightly press against the enlarged open end (41) of the hose. When the included angle (θ) is greater than 95 degrees, the hose (40) easily slips off the insertion section (11) of the bushing (10). The fifth embodiment of the hose connector (1) has multiple collars (30) axially arranged abreast.

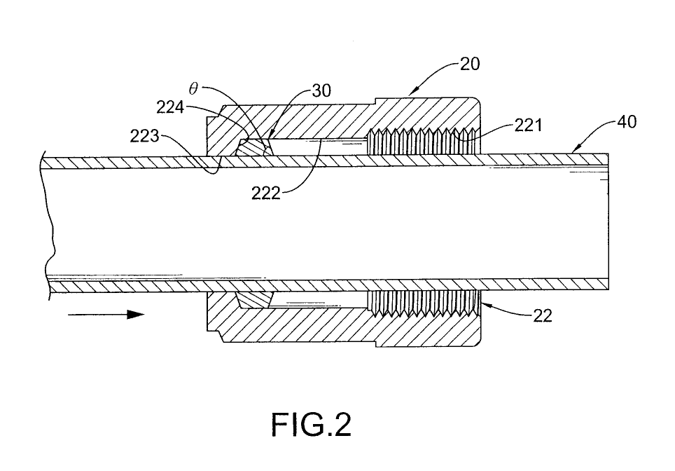

With further reference to FIGS. 2 to 4, a method for fabricating the hose connector (1) on the hose (40) in accordance with present invention comprises a nut mounting step, a bushing mounting step and an engaging step.

The nut mounting step comprises mounting the hose (40) through the nut (20) and the at least one collar (30), as shown in FIG. 2.

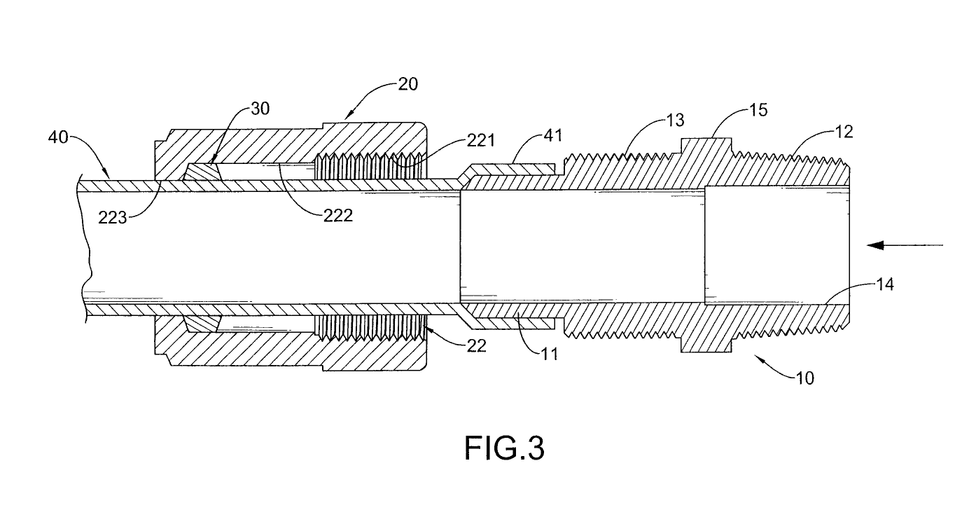

The bushing mounting step comprises mounting the insertion section (11) of the bushing (10) in the open end (41) of hose (40). The open end (41) is enlarged by the insertion section (11) of the bushing (10), as shown in FIG. 3.

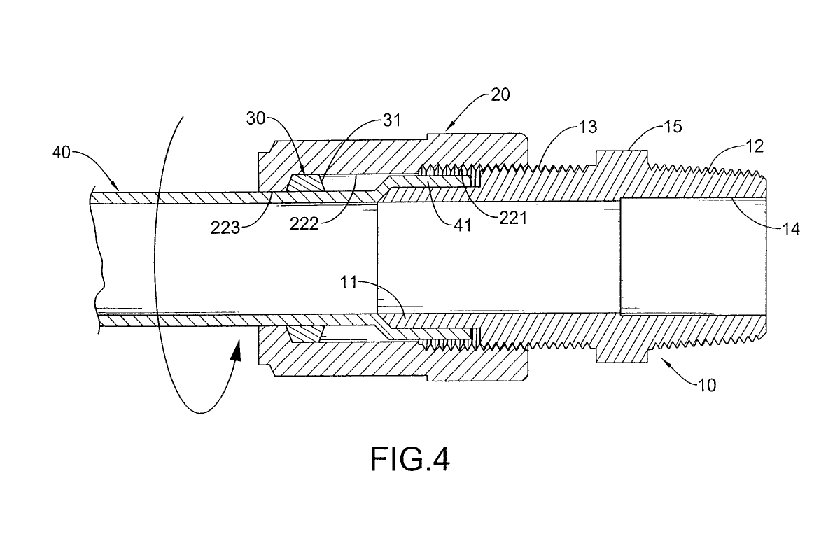

The engaging step comprises engaging the engaging thread (221) on the nut (20) with the engaging thread (13) on the bushing (10). The at least one collar (30) is pushed by the compressing flange (223) on the nut (20) to move toward the bushing (10). Then the at least one collar (30) presses tightly against the enlarged open end (41) of the hose (41) and cooperates with the insertion section (11) of the bushing (10) to clamp the enlarged open end (41) and therefore prevents the enlarged open end (41) from falling out of the hose connector (1), as shown in FIGS. 4 and 5.

The insertion section (11) of the bushing and the at least one collar (30) cooperate to tightly hold the hose (40) in the hose connector (1). Thus, the hose (40) cannot fall out of the hose connector (1) inadvertently when external forces pull the hose (40) or the hose connector (41). The at least one collar (30) is rotatably mounted in the nut (20) does not rotate with the nut (20) when the nut is screwed onto the bushing (10). Thus, the at least one collar (30) would not wear or cut the hose (40) and prevents the hose (40) from being damaged and leaking.

A following table shows comparison of tensile strength of the hose connector of the present invention with conventional hose connector.

Comparison Table in Tensile Strength of Hose Connectors

| | | Tensile | Tensile |
|---|---|---|---|
| | | Strength of | Strength of |
| | Tensile Strength of | 1^{st} Conventional | 2^{nd} Conventional |
| | The Present Invention | Hose Connector | Hose Connector |
| Size (inch) | (Kg) | (Kg) | (Kg) |
| ¼″ | 30-40 | 18 | 28 |
| ⅜″ | 60-65 | 40 | 50 |
| ½″ | 85-90 | 50 | 70 |
| ¾″ | 135-145 | 90 | 130 |
| 1″ | 170-180 | 110 | 160 |

As shown by the aforementioned Table, the tensile strength of the hose connector (1) of the present invention is a great advancement over conventional hose connectors.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hose connector adapted to be mounted on an open end of a hose, the hose connector comprising:
a bushing having
an outer surface;
an inside end;
an outside end being opposite to the inside end;
a central hole being defined axially through the bushing and having an inner surface;
an insertion section attached to the bushing adjacent to the inside end, having an outer diameter adapted to be inserted into and enlarging the open end of the hose;
an engaging thread being formed on the outer surface of the bushing adjacent to the insertion section and having an outer diameter larger than that of the insertion section;
a nut being cylindrical, mounted detachably around the bushing, adapted to be mounted around the hose and having
a connecting end;
a compressing end being opposite to the connecting end;
a mounting hole being defined axially through the nut, being mounted around the bushing and having an inner surface;
an engaging thread being formed on the inner surface of the mounting hole adjacent to the engaging end and detachably engaging the engaging thread on the bushing; and
a compressing flange formed on and protruding radially inward from the inner surface of the mounting hole adjacent to the compressing end; and
at least one collar being annular, adapted to be mounted around the hose, mounted rotatably in the mounting hole in the nut, abutting the compressing flange, aligning with the insertion section of the bushing, and being pressed by the compressing flange to adapted to press tightly against the enlarged open end of the hose, and each collar having
an inside surface adapted to contact the hose; and
two opposite side surfaces.

2. The hose connector as claimed in claim 1, wherein each side surface of each collar has an included angle between the inside surface and the side surface of the collar in a range of 30 to 95 degrees.

3. The hose connector as claimed in claim 2, wherein the bushing further has an outside thread being formed the outer surface of the bushing at the outside end.

4. The hose connector as claimed in claim 3, wherein the bushing further has a tool operating flange being annular and polygonal, being formed on and protruding radially out from the bushing between the engaging thread and the outside thread.

5. The hose connector as claimed in claim 4, wherein the hose connector has multiple collars mounted rotatably in the mounting hole in the nut and are axially arranged abreast.

6. The hose connector as claimed in claim 4, wherein the engaging thread of the nut is formed partially on the inner surface of the mounting hole at an interval from the compressing end of the nut.

7. The hose connector as claimed in claim 4, wherein the engaging thread of the nut is formed all along the inner surface of the mounting hole.

8. The hose connector as claimed in claim 4, wherein the insertion section is formed integrally on the bushing.

9. The hose connector as claimed in claim 4, wherein the bushing has
a bushing member including the outside end and central hole defined through the bushing member and having
two open ends; and
an annular recess being defined in the inner surface of the central hole at one open end and having an inner diameter and a side surface; and
an inner cylinder being mounted detachably in the annular recess and having
a first end on which the insertion section is formed;
a second end detachably in the annular recess; and
an outer diameter; and
wherein the engaging thread of the bushing is formed on the bushing member.

10. The hose connector as claimed in claim 6, wherein the bushing has
a bushing member including the outside end and central hole defined through the bushing member and having
two open ends; and
an annular recess being defined in the inner surface of the central hole at one open end and having an inner diameter and a side surface; and
an inner cylinder being mounted detachably in the annular recess and having
a first end on which the insertion section is formed;
a second end detachably in the annular recess; and
an outer diameter.

11. The hose connector as claimed in claim 9, wherein the inner diameter of the annular recess in the bushing member is equal to the outer diameter of the inner cylinder.

12. The hose connector as claimed in claim 10, wherein the inner diameter of the annular recess in the bushing member is equal to the outer diameter of the inner cylinder.

13. The hose connector as claimed in claim 9, wherein the inner diameter of the annular recess in the bushing member is larger than the outer diameter of the inner cylinder to define a gap between the side surface of the annular recess and the inner cylinder for receiving the open end of the hose.

14. The hose connector as claimed in claim 10, wherein the inner diameter of the annular recess in the bushing member is larger than the outer diameter of the inner cylinder to define a gap between the side surface of the annular recess and the inner cylinder and for receiving the open end of the hose.

15. A method for fabricating a hose connector on a hose, the hose connector having a bushing, a nut and at least one collar, the hose having an open end, and the method comprising:
a nut mounting step comprising mounting the hose through the nut and the at least one collar;
a bushing mounting step comprising mounting an insertion section of the bushing in the open end of hose, wherein the open end of the hose is enlarged by the insertion section of the bushing; and
an engaging step comprising engaging an engaging thread on the nut with an engaging thread on the bushing, wherein the at least one collar is pushed by a compressing flange on the nut to move toward the bushing, the at least one collar presses tightly against the enlarged open end of the hose, cooperates with the insertion section of the bushing to clamp the enlarged open end of the hose.

16. The method as claimed in claim 15, wherein:
the bushing has
an outer surface;
an inside end;
an outside end being opposite to the inside end;
a central hole being defined axially through the bushing and having an inner surface;
the insertion section attached to the bushing adjacent to the inside end, having an outer diameter being inserted into the open end of the hose;
the engaging thread being formed on the outer surface of the bushing adjacent to the insertion section and being larger in diameter than the insertion section;
the nut is cylindrical, is mounted detachably around the bushing and mounted around the hose and has
a connecting end;
a compressing end being opposite to the connecting end;
a mounting hole being defined axially through the nut, being mounted around the bushing and having an inner surface;
the engaging thread being formed on the inner surface of the mounting hole adjacent to the engaging end detachably engaging the engaging thread on the bushing; and
the compressing flange being formed on and protruding radially inward from the inner surface of the mounting hole adjacent to the compressing end; and
the at least one collar is annular, is mounted around the hose, is mounted rotatably in the mounting hole in the nut, abuts the compressing flange, aligns with the insertion section of the bushing and is pressed by the compressing flange to press tightly against the enlarged open end of the hose, and each collar has
an inside surface contacting the hose; and
two opposite side surfaces.
